(19) United States
(12) Patent Application Publication
(10) Pub. No.: US 2021/0203172 A1
(43) Pub. Date: Jul. 1, 2021

(54) Charging Station Assembly

(71) Applicant: Christopher Deaton, Indianapolis, IN (US)

(72) Inventor: Christopher Deaton, Indianapolis, IN (US)

(21) Appl. No.: 16/728,446

(22) Filed: Dec. 27, 2019

(51) Int. Cl. H02J 7/00; B60L 53/51; B60L 53/14; H02B 1/52

(52) U.S. Cl. CPC H02J 7/0042; B60L 53/51; B60L 2200/40; H02B 1/52; B60L 53/14

(57) ABSTRACT

A charging station assembly for charging power tool batteries in a remote location includes a solar panel that is attached to an outer surface of a vehicle. A battery is attached to the vehicle and the battery is in electrical communication with the solar panel such that the solar panel charges the battery. A bracket is mountable within a cab of the vehicle such that the bracket is accessible to a driver. A power strip is coupled to the bracket and the power strip is in electrical communication with the battery. The power strip has the battery chargers plugged therein for charging power tool batteries.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to charging devices and more particularly pertains to a new charging device for charging power tool batteries in a vehicle.

### (2) Description of Related Art Including Information Disclosed Under 37 CFR 1.97 and 1.98

The prior art relates to charging devices. The prior art discloses a variety of solar powered battery chargers, each integrated into a vehicle, for powering battery chargers. In no instance does the prior art include a shelf for supporting battery chargers in a cab of a vehicle. The prior art discloses a solar powered charging station that has a variety of different power outputs for charging a variety of different electronic devices. The prior art discloses a solar panel array that is mounted to a roof of a vehicle.

### BRIEF SUMMARY OF THE INVENTION

An embodiment of the disclosure meets the needs presented above by generally comprising a solar panel that is attached to an outer surface of a vehicle. A battery is attached to the vehicle and the battery is in electrical communication with the solar panel such that the solar panel charges the battery. A bracket is mountable within a cab of the vehicle such that the bracket is accessible to a driver. A power strip is coupled to the bracket and the power strip is in electrical communication with the battery. The power strip has the battery chargers plugged therein for charging power tool batteries.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a charging station assembly according to an embodiment of the disclosure.

FIG. 2 is a left side in-use view of an embodiment of the disclosure.

FIG. 3 is a top in-use view of an embodiment of the disclosure.

FIG. 4 is an interior view of a cab on a vehicle of an embodiment of the disclosure.

FIG. 5 is a schematic view of an embodiment of the disclosure.

### DETAILED DESCRIPTION OF THE INVENTION

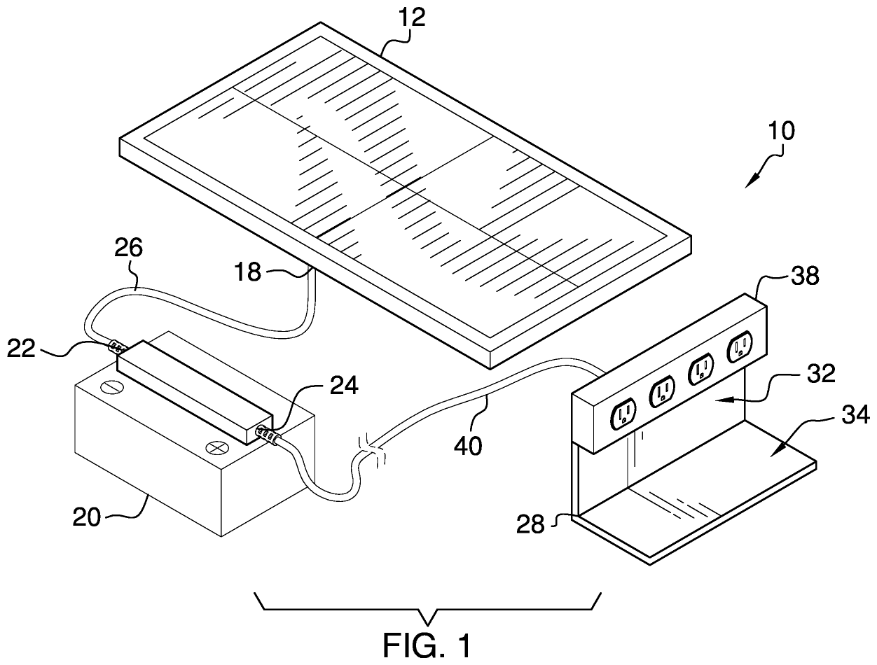

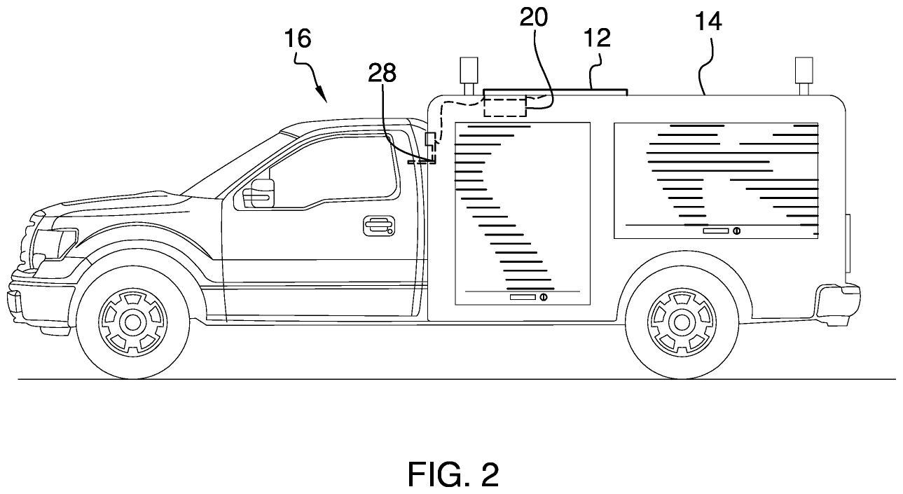

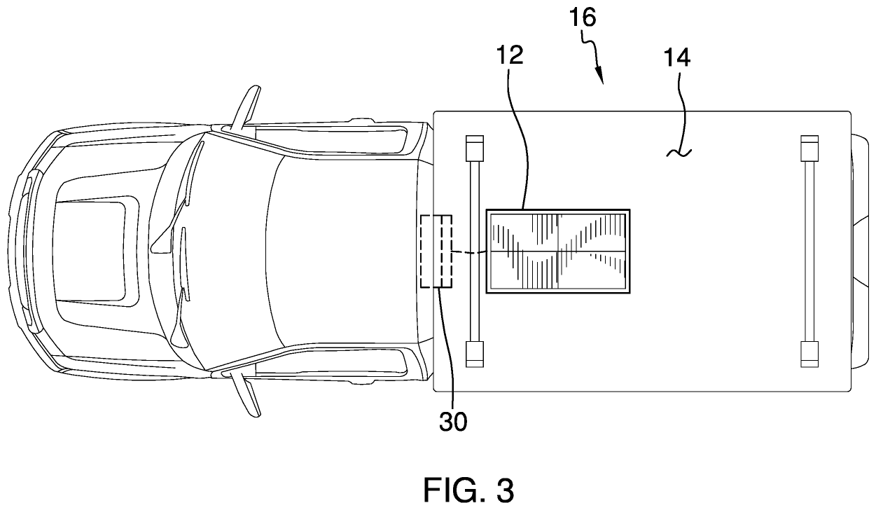

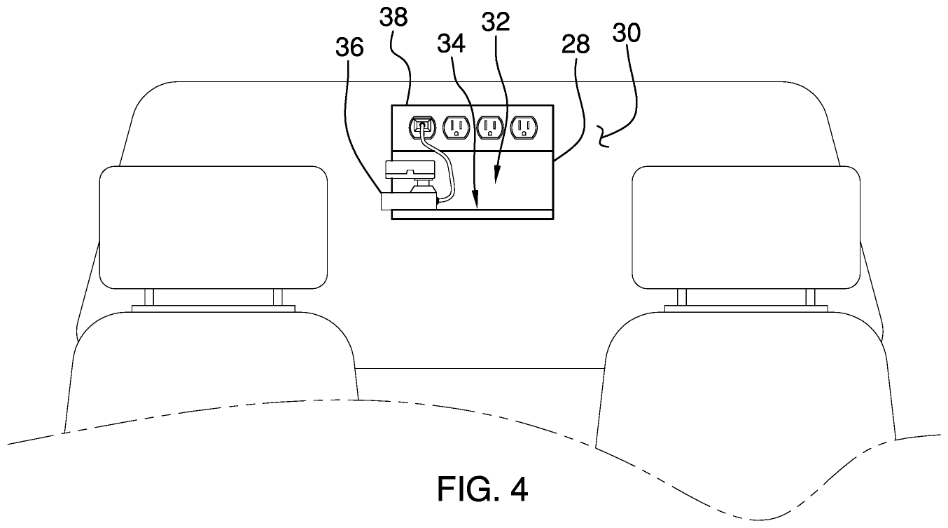

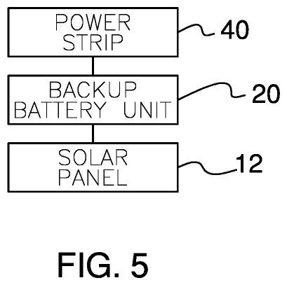

With reference now to the drawings, and in particular to FIGS. 1 through 5 thereof, a new charging device embodying the principles and concepts of an embodiment of the disclosure and generally designated by the reference numeral 10 will be described.

As best illustrated in FIGS. 1 through 5, the charging station assembly 10 generally comprises a solar panel 12 that is attached to an outer surface 14 of a vehicle 16 such that the solar panel 12 is exposed to sunlight. The solar panel 12 has an output 18 and the vehicle 16 may be a construction vehicle, a commercial vehicle or any other type of motorized vehicle that is driven on work sites, construction sites or any other location that routinely involves the use of cordless power tools. A battery 20 is attached to the vehicle 16 and the battery 20 is in electrical communication with the solar panel 12 such that the solar panel 12 charges the battery 20. The battery 20 has an input 22 and an output 24, and the battery 20 is discrete from a battery in the vehicle's electrical system.

A first conductor 26 is electrically coupled between the output 18 of the solar panel 12 and the input 22 of the battery 20. A bracket 28 is mountable within a cab 30 of the vehicle 16 such that the bracket 28 is accessible to a driver. The bracket 28 has a first portion 32 forming an angle with a second portion 34. The first portion 32 is attached to a vertical support surface 36 in the vehicle 16 having the second portion 34 is oriented on a horizontal plane. In this way the second portion 34 defines a shelf for supporting battery chargers 36 for power tools.

A power strip 38 is provided and the power strip 38 is coupled to the bracket 28. The power strip 38 is in electrical communication with the battery 20. Additionally, the power strip 38 has the battery chargers 36 plugged therein for charging power tool batteries. The power strip 38 is positioned on the first portion 32 of the bracket 28. A second conductor 40 is electrically coupled between the output of the battery 20 and the power strip 38 for supplying voltage to the power strip 38. An inverter 42 may be included and the inverter 42 may be electrically coupled to the battery 20 for converting DC voltage into AC voltage for the battery chargers 36.

In use, the battery chargers 36 for the power tools are placed on the second portion 34 of the bracket 28 and each of the battery chargers 36 is plugged into the power strip 38. In this way the battery chargers 36 can charge power tool batteries in a remote location that may not have electrical power. The solar panel 12 continuously charges the battery 20 while the solar panel 12 is exposed to sunlight. Thus, construction workers, industrial workers or any other workers can repeatedly charge power tool batteries in any location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A charging station assembly being integrated into a vehicle thereby facilitating power tool batteries to be recharged, said assembly comprising:
a solar panel being attached to an outer surface of a vehicle wherein said solar panel is configured to be exposed to sunlight, said solar panel having an output;
a battery being attached to the vehicle, said battery being in electrical communication with said solar panel such that said solar panel charges said battery;
a bracket being mountable within a cab of the vehicle wherein said bracket is configured to be accessible to a driver; and
a power strip being coupled to said bracket, said power strip being in electrical communication with said battery, said power strip having the battery chargers plugged therein for charging power tool batteries.

2. The assembly according to claim 1, wherein:
said battery has an input and an output; and
said assembly includes a first conductor being electrically coupled between said output of said solar panel and said input of said battery.

3. The assembly according to claim 1, wherein said bracket has a first portion forming an angle with a second portion, said first portion being attached to a vertical support surface in the vehicle having said second portion being oriented on a horizontal plane such that said second portion defines a shelf for supporting battery chargers for power tools.

4. The assembly according to claim 3, wherein said power strip is positioned on said first portion of said bracket.

5. The assembly according to claim 2, further comprising a second conductor being electrically coupled between said output of said battery and said power strip for supplying voltage to said power strip.

6. A charging station assembly being integrated into a vehicle thereby facilitating power tool batteries to be recharged, said assembly comprising:
a solar panel being attached to an outer surface of a vehicle wherein said solar panel is configured to be exposed to sunlight, said solar panel having an output;
a battery being attached to the vehicle, said battery being in electrical communication with said solar panel such that said solar panel charges said battery, said battery having an input and an output;
a first conductor being electrically coupled between said output of said solar panel and said input of said battery;
a bracket being mountable within a cab of the vehicle wherein said bracket is configured to be accessible to a driver, said bracket having a first portion forming an angle with a second portion, said first portion being attached to a vertical support surface in the vehicle having said second portion being oriented on a horizontal plane such that said second portion defines a shelf for supporting battery chargers for power tools;
a power strip being coupled to said bracket, said power strip being in electrical communication with said battery, said power strip having the battery chargers plugged therein for charging power tool batteries, said power strip being positioned on said first portion of said bracket; and
a second conductor being electrically coupled between said output of said battery and said power strip for supplying voltage to said power strip.

7. A charging station system comprising:
a vehicle having an outer surface and a cab;
a solar panel being attached to said outer surface of said vehicle wherein said solar panel is configured to be exposed to sunlight, said solar panel having an output;
a battery being attached to said vehicle, said battery being in electrical communication with said solar panel such that said solar panel charges said battery, said battery having an input and an output;
a first conductor being electrically coupled between said output of said solar panel and said input of said battery;
a bracket being mountable within said cab of said vehicle wherein said bracket is configured to be accessible to a driver, said bracket having a first portion forming an angle with a second portion, said first portion being attached to a vertical support surface in said vehicle having said second portion being oriented on a horizontal plane such that said second portion defines a shelf for supporting battery chargers for power tools;
a power strip being coupled to said bracket, said power strip being in electrical communication with said battery, said power strip having the battery chargers plugged therein for charging power tool batteries, said power strip being positioned on said first portion of said bracket; and
a second conductor being electrically coupled between said output of said battery and said power strip for supplying voltage to said power strip.
